(19) United States
(12) Patent Application Publication
(10) Pub. No.: US 2019/0385134 A1
(43) Pub. Date: Dec. 19, 2019

(54) ALERT ISSUANCE FOR LOW-UTILITY AUTO-RENEWING SUBSCRIPTION SERVICES

(71) Applicant: INTERNATIONAL BUSINESS MACHINES CORPORATION, Armonk, NY (US)

(72) Inventors: Martin G. KEEN, Cary, NC (US); Adam SMYE-RUMSBY, Reading, PA (US); Hernan A. CUNICO, Holly Springs, NC (US); Paul Alexander Raphael FRANK, Hamburg (DE)

(21) Appl. No.: 16/009,086

(22) Filed: Jun. 14, 2018

(51) Int. Cl. G06Q 20/10; G06F 17/21; H04L 29/08; G06Q 20/34; G06Q 20/40; G06F 15/18

(52) U.S. Cl. CPC G06Q 20/102; G06F 17/21; G06F 15/18; G06Q 20/351; G06Q 20/407; H04L 67/26

(57) ABSTRACT

Computer-implemented sending of notifications is disclosed and includes identifying, using natural language understanding and natural language classification, auto-renewing subscription service(s) associated with a user based on content of computing device(s) associated with the user and internet-available sources, the identifying resulting in identified auto-renewing subscription service(s). For each of the identified auto-renewing subscription service(s), analyzing, using cognitive computing, usage by the user of each of the identified auto-renewing subscription service(s) to determine whether a given auto-renewing subscription service of the identified auto-renewing subscription service(s) meets one or more criterion for cancelation, and, responsive to a determination that the one or more criterion for cancelation are met for the given auto-renewing subscription service, sending a notification to the user indicating the given auto-renewing subscription service and a corresponding date a fee is scheduled to be charged to renew the given auto-renewing subscription service.

### BACKGROUND

The present disclosure relates to auto-renewing subscription services. More particularly, the present disclosure relates to issuing alerts to users for low-utility auto-renewing subscription services prior to renewal.

Many services offer periodic automatic renewals. Automatic renewals are a recurring service a user has signed up for that is billed periodically, typically to a credit card on file. For example, such services may include: subscriptions to publications such as a magazine or book club; annual fees for a credit card; software subscriptions (including mobile applications); and video streaming services.

It can often be difficult for a user to keep track of all of their renewals, frequently resulting in payments for a service that a user is no longer using and would not have elected to continue if they had been reminded about it. For example a user may: pay an annual fee for a credit card they no longer use; pay monthly subscriptions for a software application they launch only rarely; and buy another year of a digital magazine which they are not regularly reading.

### SUMMARY

Shortcomings of the prior art are overcome, and additional advantages are provided, through the provision, in one aspect, of a computer-implemented method. The method can include, for example: identifying, using natural language understanding and natural language classification, one or more auto-renewing subscription services associated with a user based on at least one of content of at least one computing device associated with the user and one or more network-available sources, the one or more network-available sources comprising one or more sources on a global computer network, the identifying resulting in at least one identified auto-renewing subscription service. The method further includes, analyzing, using cognitive computing, usage by the user of each of the at least one identified auto-renewing subscription services to determine whether a given auto-renewing subscription service of the at least one identified auto-renewing subscription service meets one or more criterion for cancelation; and, responsive to a determination that the one or more criterion for cancelation are met for the given auto-renewing subscription service of the at least one identified auto-renewing subscription service, sending a notification to the user indicating the given auto-renewing subscription service and a corresponding date a fee is scheduled to be charged to renew the given auto-renewing subscription service.

In another aspect, a system can be provided. The system can include, for example, a memory and at least one processor in communication with the memory to perform a method. The method can include, for example: identifying, using natural language understanding and natural language classification, one or more auto-renewing subscription services associated with a user based on at least one of content of at least one computing device associated with the user and one or more network-available sources, the one or more network-available sources comprising one or more sources on a global computer network, the identifying resulting in at least one identified auto-renewing subscription service, analyzing, using cognitive computing, usage by the user of each of the at least one identified auto-renewing subscription services to determine whether a given auto-renewing subscription service of the at least one identified auto-renewing subscription service meets one or more criterion for cancelation; and, responsive to a determination that the one or more criterion for cancelation are met for the given auto-renewing subscription service of the at least one identified auto-renewing subscription service, sending a notification to the user indicating the given auto-renewing subscription service and a date a corresponding fee is scheduled to be charged to renew the given auto-renewing subscription service.

In a further aspect, a computer program product can be provided. The computer program product can include, for example, a non-transitive storage medium readable by a processor and storing instructions for performing a method of sending notifications. The method can include, for example: identifying, using natural language understanding and natural language classification, one or more auto-renewing subscription services associated with a user based on at least one of content of at least one computing device associated with the user and one or more network-available sources, the one or more network-available sources comprising one or more sources on a global computer network, the identifying resulting in at least one identified auto-renewing subscription service; analyzing, using cognitive computing, usage by the user of each of the at least one identified auto-renewing subscription services to determine whether a given auto-renewing subscription service of the at least one identified auto-renewing subscription service meets one or more criterion for cancelation; and, responsive to a determination that the one or more criterion for cancelation are met for the given auto-renewing subscription service of the at least one identified auto-renewing subscription service, sending a notification to the user indicating the given auto-renewing subscription service and a corresponding date a fee is scheduled to be charged to renew the given auto-renewing subscription service.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a flow diagram of one example of a computer-implemented method of sending notifications to users, in accordance with one or more aspects of the present disclosure.

FIG. 2 is a block diagram of one example of a system for identifying auto-renewal subscription services for a given user, in accordance with one or more aspects of the present disclosure.

FIG. 3 is a flow diagram of one example of analyzing each of the identified auto-renewal subscription services for the given user to determine if one or more criterion for cancelation is met, in accordance with one or more aspects of the present disclosure.

FIG. 4 is a flow diagram of one example of deriving a utility score for a given auto-renewal subscription service of a given user, in accordance with one or more aspects of the present disclosure.

FIG. 5 is a flow diagram of one example of notifying a given user of any relatively low-utility auto-renewal subscription services prior to the renewal date, in accordance with one or more aspects of the present disclosure.

FIG. 6 depicts one example of creating and using a natural language classifier, in accordance with one or more aspects of the present disclosure.

FIG. 7 is a block diagram of one example of a computer system, in accordance with one or more aspects of the present disclosure.

FIG. 8 is a block diagram of one example of a cloud computing environment, in accordance with one or more aspects of the present disclosure.

FIG. 9 is a block diagram of one example of functional abstraction layers of the cloud computing environment of FIG. 7, in accordance with one or more aspects of the present disclosure.

### DETAILED DESCRIPTION

The present disclosure relates to automatically renewing subscription services, such as a magazines, video streaming services, and credit cards with annual fees. Various electronic sources are analyzed (such as email, credit card statements, subscription web sites, and app stores) to identify a user's auto-renewing subscription services. A list may be made, or updated if preexisting, of all auto-renewing subscription services of the user. The list can be referenced by the user as needed. For each auto-renewing subscription service, a system, trained with data using machine learning, performs a cognitive analysis to derive the extent the user is making use of the auto-renewing subscription service and whether the subscription service meets one or more criterion for cancelation. The user is alerted to auto-renewing subscription services meeting the cancelation criteria before they are automatically renewed.

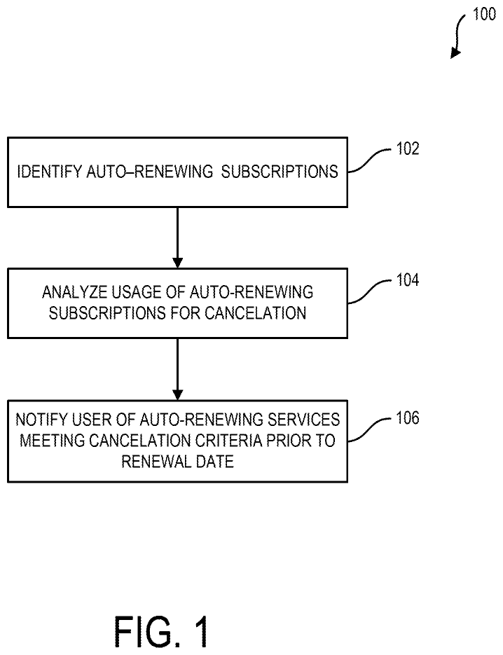

FIG. 1 is a flow diagram 100 of one example of a computer-implemented method of sending notifications to users, the notifications alerting users to an impending renewal date of an auto-renewal subscription service meeting one or more criterion for cancelation, in accordance with one or more aspects of the present disclosure. In a first aspect of the present disclosure, the method includes, for example, identifying 102, using various electronic sources, one or more auto-renewing subscription services of a user. A list of auto-renewing subscription services for the user may be created or updated, if preexisting, for reference by the user. In a second aspect of the present disclosure, the method includes, for example, analyzing 104 usage by the user of the identified auto-renewing subscription services to determine whether a given auto-renewing subscription service of the at least one identified auto-renewing subscription service meets one or more criterion for cancelation. In a third aspect of the present disclosure, the method includes, for example, notifying 106 a user of any identified auto-renewing subscription services meeting the cancelation criteria prior to the renewal date. The communication can take on many different forms, for example, an email, a text message, an automated call, etc.

The criteria for cancelation can be, for example, a number of uses by the user of a given auto-renewing subscription service being below a predetermined number of uses for the given auto-renewing subscription service. In another example, the criteria can include a number of uses of the auto-renewing subscription service being below a default number of uses or, in another example, below a user-specified number of uses or an average number of uses by a group of or all users. The criteria for cancelation can be, for example, the same or different for one or more types of auto-renewing subscription services. In yet another example, the criteria could be a score with one or more inputs contributing to the score. In one example, the user may choose cancelation criteria from among a number of choices for one or more auto-renewing subscription services. In still another example, the criteria for cancelation can be a relatively low utility score and may include an indication of a confidence level in the data used to determine the utility score. For example, a high utility score with a high confidence level will not generate a notification. However, subscription services with a low utility score or a low confidence level will generate a notification to the user. As used herein, the term “low utility” and formatives thereof can be, for example, low for the particular user, low for another similar user, low for a group of users or low for an aggregate of all users.

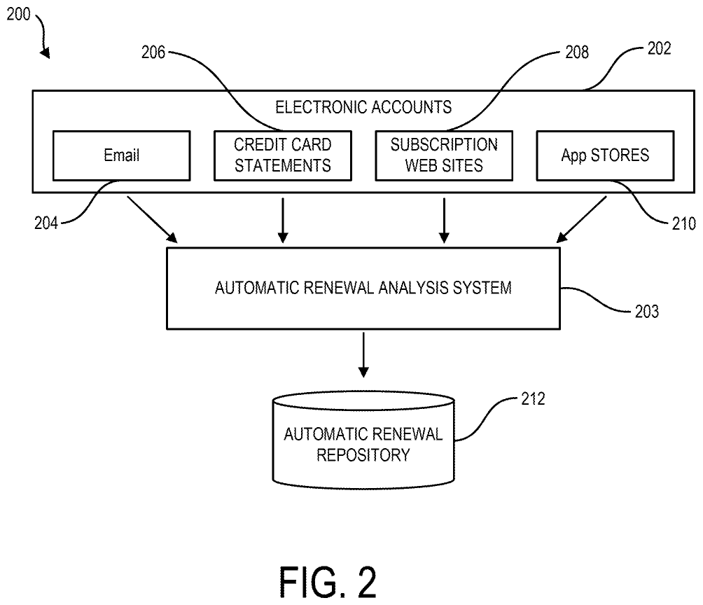

FIG. 2 is a block diagram 200 of one example of a system for identifying auto-renewal subscription services for a given user. The user may, for example, in some manner assign authorization for an Automatic Renewal Analysis System 203 to analyze the user's electronic accounts 202 to look for service subscriptions that include an automatic renewal and store information regarding the auto-renewing subscription services in an automatic renewal repository 212 (e.g., a database). The Automatic Renewal Analysis System utilizes Natural Language Understanding (previously known as, “Natural Language Processing”) and Natural Language Classification to analyze sources, described more fully below.

The sources can include, but are not limited to, information available on one or more computing devices associated with the user and/or one or more network-available sources, for example, accounts of the user accessible over, for example, a global network, e.g., the Internet, or other accessible public or private network.

With reference to FIG. 2, examples of user accounts include, but are not limited to: email accounts 204—e.g., an analysis of emails looking for receipts and order confirmations indicating services that the user has signed up for and their automatic renewal data; credit card statements 206—e.g., an analysis of recurring charges and pre-authorization of upcoming charges that may indicate an automatic renewal; subscription web sites 208—e.g., services such as video streaming, satellite radio, or genealogy with automatic renewals; app stores 210—e.g., desktop and mobile apps that incur renewals such as monthly or annual automatic charges. For each auto-renewal subscription service identified, the system obtains and stores information sufficient to renew or cancel each identified auto-renewal subscription service, for example, the following in an Automatic Renewal Repository 212: renewal service, renewal date, renewal frequency, and renewal amount. In one example, the user can view this list of automatic renewals at any time to see which services they are signed up for and when a renewal is due.

The umbrella term “Natural Language Understanding” can be applied to a diverse set of computer applications, ranging from small, relatively simple tasks such as, for example, short commands issued to robots, to highly complex endeavors such as, for example, the full comprehension of newspaper articles or poetry passages. Many real world applications fall between the two extremes, for example, text classification for the automatic analysis of emails and their routing to a suitable department in a corporation does not require in-depth understanding of the text, but it does need to work with a much larger vocabulary and more diverse syntax than the management of simple queries to database tables with fixed schemata.

Regardless of the approach used, most natural language understanding systems share some common components. The system needs a lexicon of the language and a parser and grammar rules to break sentences into an internal representation. The construction of a rich lexicon with a suitable ontology requires significant effort, for example, the WORDNET lexicon required many person-years of effort. WORDNET is a large lexical database of English. Nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated, for example, with a browser specially configured to provide the navigation functionality. WORDNET's structure makes it a useful tool for computational linguistics and natural language processing.

WORDNET superficially resembles a thesaurus, in that it groups words together based on their meanings. However, there are some important distinctions. First, WORDNET interlinks not just word forms—strings of letters—but specific senses of words. As a result, words that are found in close proximity to one another in the network are semantically disambiguated. Second, WORDNET labels the semantic relations among words, whereas the groupings of words in a thesaurus does not follow any explicit pattern other than meaning similarity.

The system also needs a semantic theory to guide the comprehension. The interpretation capabilities of a language understanding system depend on the semantic theory it uses. Competing semantic theories of language have specific trade-offs in their suitability as the basis of computer-automated semantic interpretation. These range from naive semantics or stochastic semantic analysis to the use of pragmatics to derive meaning from context.

Advanced applications of natural language understanding also attempt to incorporate logical inference within their framework. This is generally achieved by mapping the derived meaning into a set of assertions in predicate logic, then using logical deduction to arrive at conclusions. Therefore, systems based on functional languages such as the Lisp programming language need to include a subsystem to represent logical assertions, while logic-oriented systems such as those using the language Prolog, also a programming language, generally rely on an extension of the built-in logical representation framework.

A Natural Language Classifier, which could be a service, for example, applies cognitive computing techniques to return best matching predefined classes for short text inputs, such as a sentence or phrase. It has the ability to classify phrases that are expressed in natural language into categories. Natural Language Classifiers (“NLCs”) are based on Natural Language Understanding (NLU) technology (previously known as “Natural Language Processing”). NLU is a field of computer science, artificial intelligence (AI) and computational linguistics concerned with the interactions between computers and human (natural) languages.

For example, consider the following questions: “When can you meet me?” or When are you free?” or “Can you meet me at 2:00 PM?” or “Are you busy this afternoon?” NLC can determine that they are all ways of asking about “setting up an appointment.” Short phrases can be found in online discussion forums, emails, social media feeds, SMS messages, and electronic forms. Using, for example, IBM's Watson APIs (Application Programming Interface), one can send text from these sources to a natural language classifier trained using machine learning techniques. The classifier will return its prediction of a class that best captures what is being expressed in that text. Based on the predicted class one can trigger an application to take the appropriate action such as providing an answer to a question, suggest a relevant product based on expressed interest or forward the text to an appropriate human expert who can help.

Applications of such APIs include, for example, classifying email as SPAM or No-SPAM based on the subject line and email body; creating question and answer (Q&A) applications for a particular industry or domain; classifying news content following some specific classification such as business, entertainment, politics, sports, and so on; categorizing volumes of written content; categorizing music albums following some criteria such as genre, singer, and so on; combining the Watson Natural Language Classifier service with the Watson Conversation service if one wants their application to engage in a conversation with a user; and classifying frequently asked questions (FAQs).

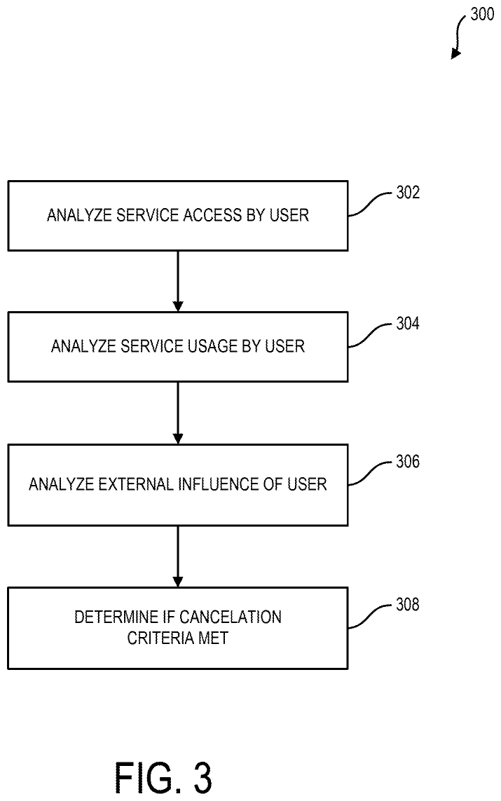

FIG. 3 is a flow diagram 300 of one example of analyzing auto-renewal subscription services for a given user to identify subscription services meeting one or more criterion for cancelation. In one example, a cognitive computer system performs the analysis. In general, the term “cognitive computing” (CC) has been used to refer to new hardware and/or software that mimics the functioning of the human brain and helps to improve human decision-making, which can be further improved using machine learning. In this sense, CC is a new type of computing with the goal of more accurate models of how the human brain/mind senses, reasons, and responds to stimulus. CC applications link data analysis and adaptive page displays (AUI) to adjust content for a particular type of audience. As such, CC hardware and applications strive to be more effective and more influential by design.

Some common features that cognitive systems may express include, for example: ADAPTIVE—they may learn as information changes, and as goals and requirements evolve. They may resolve ambiguity and tolerate unpredictability. They may be engineered to feed on dynamic data in real time, or near real time; INTERACTIVE—they may interact easily with users so that those users can define their needs comfortably. They may also interact with other processors, devices, and Cloud services, as well as with people; ITERATIVE AND STATEFUL—they may aid in defining a problem by asking questions or finding additional source input if a problem statement is ambiguous or incomplete. They may “remember” previous interactions in a process and return information that is suitable for the specific application at that point in time; and CONTEXTUAL—they may understand, identify, and extract contextual elements such as meaning, syntax, time, location, appropriate domain, regulations, user's profile, process, task and goal. They may draw on multiple sources of information, including both structured and unstructured digital information, as well as sensory inputs (e.g., visual, gestural, auditory and/or sensor-provided).

Returning to FIG. 3, service access analysis 302 tracks when the user launches a service, for example, how often a user logs in to a Web site based service. Another example includes how often an application is launched by the user on a computer, smartphone or tablet, for example. Service usage analysis 304 tracks what a user is doing with a service. For example, how many songs are streamed using a music streaming service, how often charges are applied to a credit card service and how long the user spends working in an application of an application service. External influence analysis 306 tracks how the user is making use of a service through analysis of external influences, such as social media and online chat. Examples of external influences include, for example: how often a user shares a story from a magazine service on their social media feed; how often a user discusses a book through analysis of calendar entries (for attending sessions of a book club service), emails, and online chat transcripts. The system analyzes the factors to determine if one or more criterion for cancelation are met 308 for a given auto-renewing subscription service of the user.

In one example, the cancelation determination includes deriving a relative utility score indicating the value a user is receiving from a subscription. The utility score can take many different forms, for example, the utility score could be a number in a range, e.g., zero (least utilization) to 100 (greatest utilization). An indication of a confidence level of the data used to make the cancelation determination may be assigned to each auto-renewing subscription service of the user. In one example, a utility score may be assigned and the confidence level indication can be for data used to assign the utility score. Like the utility score, the confidence level can take many different forms. In one example, the confidence level can take the form of a number in a range, e.g., 1-10 with 1 being the lowest confidence level and 10 being the highest confidence level.

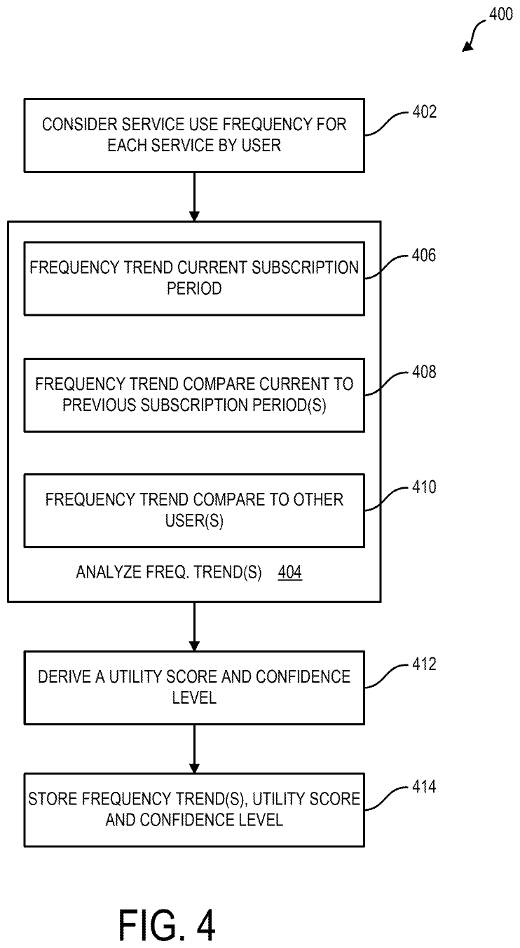

FIG. 4 is a flow diagram 400 of one example of deriving a utility score and a confidence level for a given auto-renewal subscription service of a given user. The score addresses, for example, factors such as, for example, service use frequency 402, which is how often a user is making use of the service. For example, a user that has used a service 20 times over the lifetime of the subscription has a higher Utility Score relative to another user who has used a service five times over the same period. This can also be applied to external influence, for example, how many times a user posted to a social network about a particular service.

In one example, one or more frequency trends may be analyzed 404. For example, a frequency trend of usage over time over a current subscription period 406 looks for patterns indicating trends in service usage and influence. For example, a service with high initial usage at the start of the subscription (e.g., once per week), changing to a lower usage near the end of the subscription (e.g., once per month) would receive a lower Utility Score than the reverse situation.

As another example, a frequency trend compared to previous subscription periods 408 can be analyzed, as well as a comparison of usage and influence in the current subscription period with all previous subscription periods. For example, in the current subscription period, a user that billed 10 transactions to their credit card compared to the previous subscription periods where the user billed 75-85 transactions. The lower frequency of usage compared to the baseline lowers the Utility Score.

In yet another example, frequency trend can be compared to aggregate users or a peer group 410. For example, if a user only posts a transaction to a credit card five times per year but an average user posts transactions 60 times per year, this could lead to a low utility score. In addition, the user's frequency of using a service, for example, can be applied to a specific peer group. For example, a user uses their credit card only for vacation expenses because of its favorable costs when used abroad. When comparing the usage to the peer group of vacation users, five times per year indicates a normal utility score. Each subscription service is assigned a Utility Score and a confidence level 412, the confidence level indicating the strength of the data that was analyzed to generate the Utility Score. In one example, the utility score, confidence level and frequency trend are stored in a database 414. The Utility Score may be continually or periodically re-calculated over the course of the subscription.

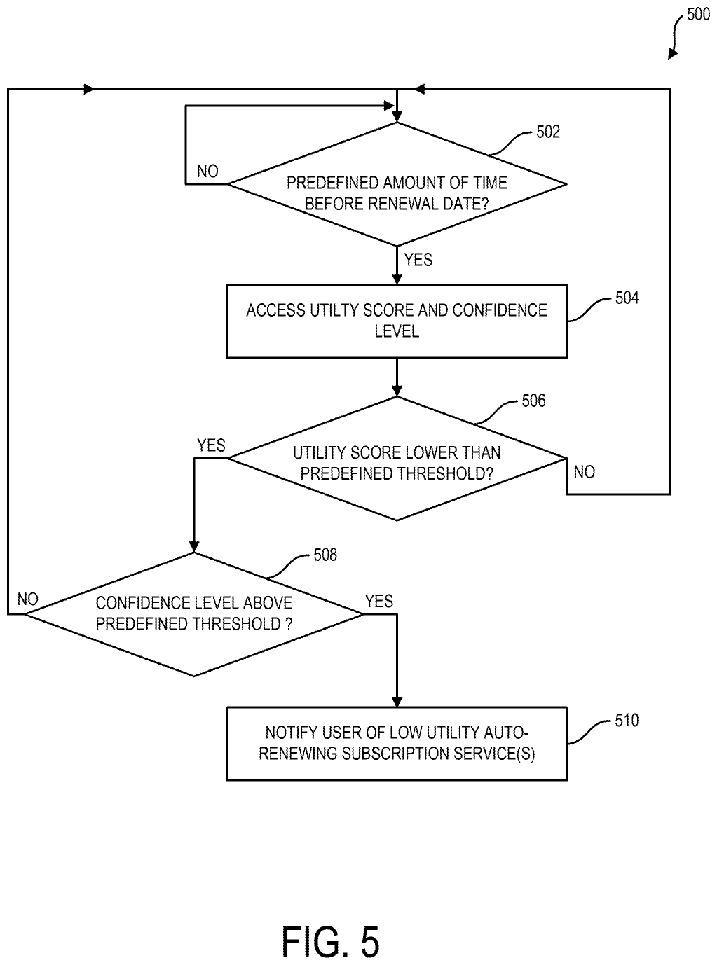

FIG. 5 is a flow diagram 500 for one example of notifying a given user of any relatively low-utility auto-renewal subscription services based on the utility score and confidence level of FIG. 4, prior to the renewal date. In one example, the notification is given far enough in advance of renewal to allow the user to cancel the subscription, for example, a month prior to the renewal date. At a predetermined time before renewal 502 (e.g., a month), the utility score and confidence level are accessed 504. If the utility score is below a predetermined threshold 506, it is determined whether the confidence level is above a predetermined threshold 508. If the confidence level is above the threshold, the user is notified of the low-utility auto-renewal subscription service prior to the date of renewal.

In one example, the user may receive the following alerts: Auto-renewal alert for a music streaming service, indicating that, for example, the renewal is due in two days at a renewal cost of $10.00 per month having a Utility Score of 20/100. Such alerts may also include factors influencing the utility score such as, for example, total service usage in the current period, e.g., six songs played and having a frequency of no songs played in last 15 days. In one example, a comparison may be made to a baseline, for example, 120 songs played per period on average. In one example, the user can elect to allow the auto renewal to take place or can cancel the service before the date of auto renewal. In another example, if cancelation can be done fully electronically, the user may have the choice to have the low-utility auto-renewal subscription notification service cancel for them.

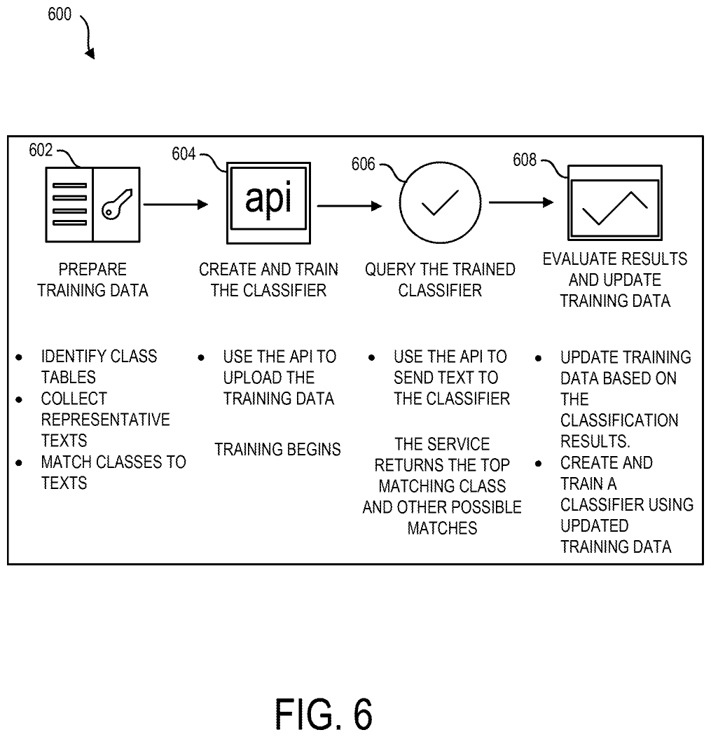

FIG. 6 is a hybrid flow diagram 600 of one example of an overview of the basic steps for creating and using a natural language classifier service. Initially, training data for machine learning is prepared, 602, by identifying class tables, collecting representative texts and matching the classes to the representative texts. An API (Application Planning Interface) may then be used to create and train the classifier 604 by, for example, using the API to upload training data. Training may begin at this point. After training, queries can be made to the trained natural language classifier, 606. For example, the API may be used to send text to the classifier. The classifier service then returns the matching class, along with other possible matches. The results may then be evaluated and the training data updated, 608, for example, by updating the training data based on the classification results. Another classifier can then be trained using the updated training data.

Certain embodiments herein may offer various technical computing advantages involving computing advantages to address problems arising in the realm of computer networks. Certain embodiments herein may offer various technical computing advantages addressing problems arising in the realm of computer networks and computer systems. Embodiments herein can employ machine learning processing to facilitate analysis of a wide variety of data sources. An auto-renewal database can use a predictive model trained by machine learning with various data from a variety of sources, such as information local to the user and network-available sources, to intelligently determine a utility for a given auto-renewal subscription service for a given user.

Computer systems may be operated to use cognitive computing techniques to provide a service. In particular, as disclosed herein, a service that notifies a user prior to an auto-renewal subscription service renewal date that the subscription service has a low utility. In order to provide this service, the auto-renewal subscription services for a given user are identified using natural language understanding and natural language classification to understand and analyze user information to the extent authorized by the user, such as, for example, email, SMS messages, account statements and social media posts. Various types of analyses can be used, such as, for example, tracking service launch, analyzing the usage of the subscription service by the users and an analysis of the effect of external influences on usage of the subscription service by the user.

A utility score for a given subscription service of the user is derived from various information, such as, for example, service use frequency, relevant social network post frequency, as well as identifying various frequency trends, such as, for example, usage over time in the current service period, as compared to a previous service period and comparisons of user usage of the service against that of another user, a group of users and/or an aggregate of users of the subscription service. A notification of low-utility subscription services may then be sent to the user prior to the renewal date.

Various decision data structures can be used to drive artificial intelligence (AI) decision making, such as decision data structure that cognitively maps social media interactions in relation to posted content in respect to parameters for use in better allocations that can include allocations of digital rights. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms.

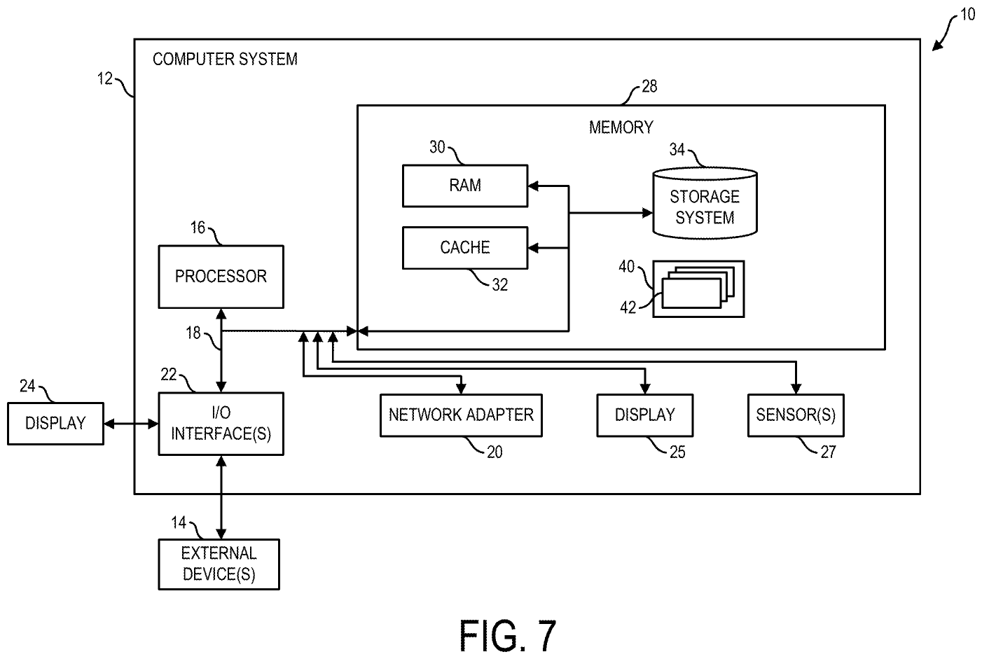

FIGS. 7-9 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 7, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

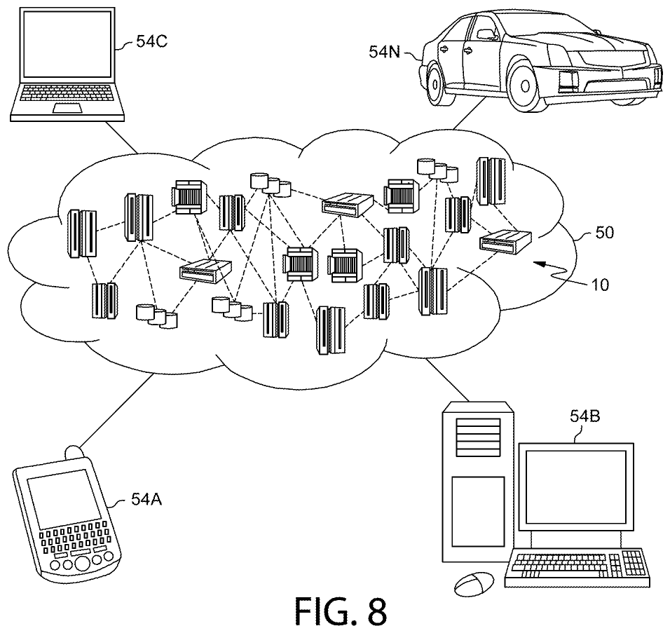

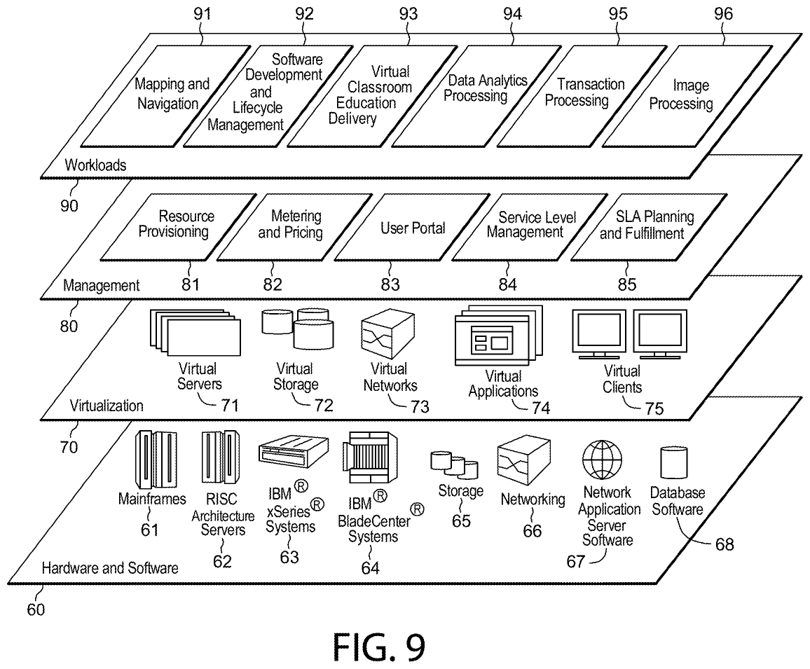

As shown in FIG. 7, computer system 12 in computing node 10 is shown in the form of a computing device. The components of computer system 12 may include, but are not limited to, one or more processor 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 8-9.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 including program processes 42 can generally carry out the functions set forth herein. One or more program 40 including program processes 42 can define machine logic to carry out the functions set forth herein. In one embodiment, manager system 110 can include one or more computing node 10 and can include one or more program 40 for performing functions described with reference to method 200 of FIG. 2 and functions described with reference to method 300 of FIG. 3 and functions described with reference to manager system 110 as set forth in the flowchart of FIG. 4.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18.

It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which can be configured to provide user interface functionality, computing node 10 in one embodiment can include display 25 connected to bus 18.

In one embodiment, display 25 can be configured as a touch screen display and can be configured to provide user interface functionality, e.g. can facilitate virtual keyboard functionality and input of total data. Computer system 12 in one embodiment can also include one or more sensor device 27 connected to bus 18. One or more sensor device 27 can alternatively be connected through I/O interface(s) 22. One or more sensor device 27 can include a Global Positioning Sensor (GPS) device in one embodiment and can be configured to provide a location of computing node 10. In one embodiment, one or more sensor device 27 can alternatively or in addition include, e.g., one or more of a camera, a gyroscope, a temperature sensor, a humidity sensor, a pulse sensor, a blood pressure (bp) sensor or an audio input device. Computer system 12 can include one or more network adapter 20. In FIG. 10 computing node 10 is described as being implemented in a cloud computing environment and accordingly is referred to as a cloud computing node in the context of FIG. 10.

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

Referring now to FIG. 9, a set of functional abstraction layers provided by cloud computing environment 50 (FIG. 10) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources.

User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for establishing and updating geofence locations as set forth herein. The processing components 96 can be implemented with use of one or more program 40 described in FIG. 7.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

In a first aspect, disclosed above is a computer-implemented method of sending notifications. The method includes identifying, using natural language understanding and natural language classification, auto-renewing subscription service(s) associated with a user based on at least one of content of computing device(s) associated with the user and network-available sources, the network-available sources including sources on a global computer network, the identifying resulting in identified auto-renewing subscription service(s). The method further includes, analyzing, using cognitive computing, usage by the user of each of the identified auto-renewing subscription service(s) to determine whether a given auto-renewing subscription service of the identified auto-renewing subscription service(s) meets one or more criterion for cancelation, and responsive to a determination that the one or more criterion for cancelation are met for the given auto-renewing subscription service of the identified auto-renewing subscription service(s), sending a notification to the user indicating the given auto-renewing subscription service and a corresponding date a fee is scheduled to be charged to renew the given auto-renewing subscription service.

In one example, the analyzing may include, for example, assigning a utility score to each of the identified auto-renewing service(s), and the one or more criterion for cancelation can include, for example, the utility score being below a predetermined threshold.

In one example, sending a notification in the computer-implemented method of the first aspect may include, for example, sending the notification to the user prior to the corresponding date(s) the fee is scheduled to be charged.

In one example, the given auto-renewing subscription service of the computer-implemented method of the first aspect may include, for example, a fully electronic subscription service. The method may further include, for example, (i) subsequent to sending the notification to the user and (ii) responsive to receiving an indication from the user that the user wishes to cancel the given auto-renewing subscription service, automatically canceling the given auto-renewing subscription service.

In one example, the computer-implemented method of the first aspect may further include, for example, responsive to identification of the user signing up for a new auto-renewing subscription service, generating an entry in a database that includes information needed to cancel the new auto-renewing subscription service.

In one example, the analyzing in the computer-implemented method of the first aspect may further include, for example, assigning an indicator of a confidence level in data used to determine whether the given auto-renewing subscription service meets the one or more criterion for cancelation.

In one example, determining the frequency of use in the computer-implemented method of the first aspect may include, for example, analyzing service access and service usage.

In one example, determining the frequency of use in the computer-implemented method of the first aspect may include, for example, analyzing external influence(s) on the frequency of use.

In one example, determining the frequency of use in the computer-implemented method of the first aspect may include, for example, determining trend(s) related to the frequency of use. In one example, the trend(s) may include, for example, at least one of a frequency trend over a current subscription period, a frequency trend compared to previous subscription period(s) and a frequency trend compared to other user(s).

In a second aspect, disclosed above is a system for sending notifications. The system includes, for example, a memory, and processor(s) in communication with the memory to perform a method. The method includes identifying, using natural language understanding and natural language classification, auto-renewing subscription service(s) associated with a user based on at least one of content of computing device(s) associated with the user and network-available sources, the network-available sources including sources on a global computer network, the identifying resulting in identified auto-renewing subscription service(s). The method further includes, analyzing, using cognitive computing, usage by the user of each of the identified auto-renewing subscription service(s) to determine whether a given auto-renewing subscription service of the identified auto-renewing subscription service(s) meets one or more criterion for cancelation, and, responsive to a determination that the one or more criterion for cancelation are met for the given auto-renewing subscription service of the identified auto-renewing subscription service(s), sending a notification to the user indicating the given auto-renewing subscription service and a corresponding date a fee is scheduled to be charged to renew the given auto-renewing subscription service.

In one example, the analyzing may include, for example, assigning a utility score to each of the identified auto-renewing subscription service(s), and the one or more criterion for cancelation may include, for example, the utility score being below a predetermined threshold.

In one example, determining the frequency of use in the system of the second aspect may include, for example, analyzing service access and service usage.

In one example, determining the frequency of use the system of the second aspect may include, for example, analyzing external influence(s) on the frequency of use.

In one example, determining the frequency of use in the system of the second aspect may include, for example, determining trend(s) related to the frequency of use.

In a third aspect, disclosed above is a computer program product for sending notifications. The computer program product includes a non-transitive storage medium readable by a processor and storing instructions for performing a method of sending notifications. The method includes identifying, using natural language understanding and natural language classification, auto-renewing subscription service(s) associated with a user based on at least one of content of computing device(s) associated with the user and network-available sources, the network-available sources including sources on a global computer network, the identifying resulting in identified auto-renewing subscription service(s), analyzing, using cognitive computing, usage by the user of each of the identified auto-renewing subscription service(s) to determine whether a given auto-renewing subscription service of the identified auto-renewing subscription service(s) meets one or more criterion for cancelation, and, responsive to a determination that the one or more criterion for cancelation are met for the given auto-renewing subscription service of the identified auto-renewing subscription service(s), sending a notification to the user indicating the given auto-renewing subscription service and a corresponding date a fee is scheduled to be charged to renew the given auto-renewing subscription service.

In one example, the analyzing may include, for example, assigning a utility score to each of the identified auto-renewing subscription service(s), and the one or more criterion for cancelation may include, for example, the utility score being below a predetermined threshold.

In one example, determining the frequency of use in the computer program product of the third aspect may include, for example, analyzing service access and service usage.

In one example, determining the frequency of use in the computer program product of the third aspect may include, for example, analyzing external influence(s) on the frequency of use.

In one example, determining the frequency of use in the computer program product of the third aspect may include, for example, determining trend(s) related to the frequency of use.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

Aspects of the present invention and certain features, advantages, and details thereof, are explained herein with reference to the non-limiting examples illustrated in the accompanying drawings. Descriptions of well-known materials, fabrication tools, processing techniques, etc., are omitted so as not to unnecessarily obscure aspects of the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language that may be used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” or “over” the other elements or features. Thus, the example term “below” may encompass both an orientation of above and below. The device may be otherwise oriented (e.g., rotated 90 degrees or at other orientations) and the spatially relative descriptors used herein should be interpreted accordingly. When the phrase “at least one of” is applied to a list, it is being applied to the entire list, and not to the individual members of the list.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable storage medium(s) having computer readable program code embodied thereon.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other environments may incorporate and use one or more aspects of the present invention. Further, other events may be monitored and/or other actions may be taken in response to the events. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of sending notifications, the method comprising:
identifying, using natural language understanding and natural language classification, one or more auto-renewing subscription services associated with a user based on at least one of content of at least one computing device associated with the user and one or more network-available sources, the one or more network-available sources comprising one or more sources on a global computer network, the identifying resulting in at least one identified auto-renewing subscription service;
analyzing, using cognitive computing, usage by the user of each of the at least one identified auto-renewing subscription services to determine whether a given auto-renewing subscription service of the at least one identified auto-renewing subscription service meets one or more criterion for cancelation; and
responsive to a determination that the one or more criterion for cancelation are met for the given auto-renewing subscription service of the at least one identified auto-renewing subscription service, sending a notification to the user indicating the given auto-renewing subscription service and a corresponding date a fee is scheduled to be charged to renew the given auto-renewing subscription service.

2. The computer-implemented method of claim 1, wherein the analyzing comprises assigning a utility score to each of the at least one identified auto-renewing subscription service, and wherein the one or more criterion for cancelation comprises the utility score being below a predetermined threshold.

3. The computer-implemented method of claim 1, wherein the notification is sent to the user prior to the one or more corresponding dates the fee is scheduled to be charged.

4. The computer-implemented method of claim 1, wherein the given auto-renewing subscription service comprises a full electronic subscription service, the method further comprising:
(i) subsequent to sending the notification to the user and (ii) responsive to receiving an indication from the user that the user wishes to cancel the given auto-renewing subscription service, automatically canceling the given auto-renewing subscription service if cancelation is fully electronic.

5. The computer-implemented method of claim 1, further comprising:
responsive to identification of the user signing up for a new auto-renewing subscription service, generating an entry in a database that includes information needed to cancel the new auto-renewing subscription service.

6. The computer-implemented method of claim 1, wherein the analyzing comprises assigning an indicator of a confidence level in data used to determine whether the given auto-renewing subscription service meets the one or more criterion for cancelation.

7. The computer-implemented method of claim 1, wherein determining the frequency of use comprises analyzing service access and service usage.

8. The computer-implemented method of claim 1, wherein determining the frequency of use comprises analyzing one or more external influences on the frequency of use.

9. The computer-implemented method of claim 1, wherein determining the frequency of use comprises determining one or more trends related to the frequency of use.

10. The computer-implemented method of claim 9, wherein the one or more trends comprises at least one of a frequency trend over a current subscription period, a frequency trend compared to one or more previous subscription periods and a frequency trend compared to at least one other user.

11. A system for sending notifications, the system comprising:
a memory; and
at least one processor in communication with the memory to perform a method, the method comprising:
identifying, using natural language understanding and natural language classification, one or more auto-renewing subscription services associated with a user based on at least one of content of at least one computing device associated with the user and one or more network-available sources, one or more the network-available sources comprising one or more sources on a global computer network, the identifying resulting in at least one identified auto-renewing subscription service;
analyzing, using cognitive computing, usage by the user of each of the at least one identified auto-renewing subscription services to determine whether a given auto-renewing subscription service of the at least one identified auto-renewing subscription service meets one or more criterion for cancelation; and
responsive to a determination that the one or more criterion for cancelation are met for the given auto-renewing subscription service of the at least one identified auto-renewing subscription service, sending a notification to the user indicating the given auto-renewing subscription service and a corresponding date a fee is scheduled to be charged to renew the given auto-renewing subscription service.

12. The system of claim 11, wherein the analyzing comprises assigning a utility score to each of the at least one identified auto-renewing subscription service, and wherein the one or more criterion for cancelation comprises the utility score being below a predetermined threshold.

13. The system of claim 11, wherein determining the frequency of use comprises analyzing service access and service usage.

14. The system of claim 11, wherein determining the frequency of use comprises analyzing one or more external influences on the frequency of use.

15. The system of claim 11, wherein determining the frequency of use comprises determining one or more trends related to the frequency of use.

16. A computer program product for sending notifications, the computer program product comprising:
a non-transitive storage medium readable by a processor and storing instructions for performing a method of sending notifications, the method comprising:
identifying, using natural language understanding and natural language classification, one or more auto-renewing subscription services associated with a user based on at least one of content of at least one computing device associated with the user and one or more network-available sources, the one or more network-available sources comprising one or more sources on a global computer network, the identifying resulting in at least one identified auto-renewing subscription service;
analyzing, using cognitive computing, usage by the user of each of the at least one identified auto-renewing subscription services to determine whether a given auto-renewing subscription service of the at least one identified auto-renewing subscription service meets one or more criterion for cancelation; and
responsive to a determination that the one or more criterion for cancelation are met for the given auto-renewing subscription service of the at least one identified auto-renewing subscription service, sending a notification to the user indicating the given auto-renewing subscription service and a corresponding date a fee is scheduled to be charged to renew the given auto-renewing subscription service.

17. The computer program product of claim 16, wherein the analyzing comprises assigning a utility score to the each of the at least one identified auto-renewing subscription service, and wherein the one or more criterion for cancelation comprises the utility score being below a predetermined threshold.

18. The computer program product of claim 16, wherein determining the frequency of use comprises analyzing service access and service usage.

19. The computer program product of claim 16, wherein determining the frequency of use comprises analyzing one or more external influences on the frequency of use.

20. The computer program product of claim 16, wherein determining the frequency of use comprises determining one or more trends related to the frequency of use.
